(19) United States
(12) Patent Application Publication
(10) Pub. No.: US 2015/0010123 A1
(43) Pub. Date: Jan. 8, 2015

(54) Electromagnetic Element Reactor

(71) Applicant: Charles Burdick, Bend, OR (US)

(72) Inventor: Charles Burdick, Bend, OR (US)

(21) Appl. No.: 14/307,865

(22) Filed: Jun. 18, 2014

Related U.S. Application Data
(60) Provisional application No. 61/842,848, filed on Jul. 3, 2013.

(51) Int. Cl. G21B 1/11

(52) U.S. Cl. CPC G21B 1/11
USPC 376/107

(57) ABSTRACT

A method and device for production of helium and recoverable energy is provided. The system directs a first directionalized flow of a of a first streaming population of deuterium ions to an intersection with a second directionalized flow of a second streaming population of deuterium ions opposite the first stream. At or proximate to an intersection of the two streams helium and waste energy are produced and captured.

### BACKGROUND OF THE INVENTION

1. Field of the Invention

This application claims priority to U.S. Provisional Patent application Ser. No. 61/842,848 filed on Jul. 3, 2013 which is included herein in its entirety by this reference thereto.

The present invention relates to a manner for producing helium. More particularly, the invention relates to method and electromagnetic element reactor device configured to produce helium and allowing for a concurrent harvesting of waste energy as a byproduct of that production.

2. Prior Art

Prior art conceptions regarding the reaction of hydrogen and its isotopes to form helium have invoked terminology such as “gluons” and “muons” as proposed explanations for this phenomenon, although these theorems are not mechanistically enabling. It has been attempted by practitioners of the prior art to form helium with associated energy during the reaction, from gaseous hydrogen and its isotopes. In these prior efforts, the employment of extreme heat and pressure has been taught to cause the reaction in a manner analogous to the formation of helium element by the earth's sun. However, no prior art methods for producing helium from gaseous deuterium have been commercialized as of yet nor have such been reported as being successful in allowing isolation of the target element or in achieving other sought after goals such as producing useful net quantities of energy.

One such unsuccessful prior art method that has been extensively pursued with gaseous hydrogen and deuterium has been the use of magnetic cyclotrons, in which a plasma of hydrogen or deuterium ions is subjected to an enclosing circular array of multiple magnetic fields in an attempt to induce extreme pressure to compress these species into the element helium. But decades of such attempts have failed to produce any useful quantities of helium or reach other objectives such as useful net energy production during the process.

Since 1983 it has also been reported that employment of an aqueous electrolytic technique employing deuterium oxide solvent and palladium electrodes can cause a reaction which will liberate energy, although helium production above control background levels has never been measured with this approach, and a net energy gain above that used to cause the reaction has not been realized.

Another mode of conversion of deuterium or “heavy hydrogen” is taught in Canadian Patent number 1146118. This invention provides a method for fusing deuterium into helium-4 by employing a positive decay radioactive elements a source of low energy neutrinos which, in turn, bombard deuterium to produce the fusion resulting in helium-4. However the method taught has only been employed in very small quantities of deuterium and requires weeks to complete even a very small reaction. Consequently it is not commercially feasible to produce large commercial quantities of helium and to provide energy from the reaction which may be harvested in commercial quantities.

As such, there is a continuing and unmet need for improvement in the method and apparatus employed in the field of helium production from hydrogen which in particular provides as a byproduct of the process, energy release in significant quantity for harvesting and employment commercially. Such a method and apparatus should endeavor to provide a safe and environmentally clean means for helium production as well as energy byproducts.

### SUMMARY OF THE INVENTION

The device and method herein disclosed and described overcomes the shortcomings in the prior art and provides substantially safe and environmentally clean method for conversion of deuterium or “heavy hydrogen” into helium. Employing a device such as the one herein taught to accomplish the method herein, yields in the process, commercial quantities of helium as well as significant amounts of released energy which may be harvested concurrent with the conversion process.

The method herein, operates on a novel electromagnetic stability model of the helium-4 nucleus, based upon the recognition that any neutron, within a given atomic nucleus, can essentially be considered to consist of a distinct electron in close association with a distinct proton.

Utilizing the novel abstraction disclosed herein, of configurations of distinct neutron-protons and neutron-electrons, it can be demonstrated mathematically that the energy balance of at least one instantaneous assembly of helium-4 nucleons, was calculated to be strongly favorable for nuclear stability derived from electromagnetic force alone. This calculation is illustrated in FIG. 1.

This principal as applied to the method and apparatus herein, indicates that through the utilization of wholly electromagnetic mechanisms as a platform to produce stable helium4 nuclei from lower-element precursors, such as deuterium ions, that helium may be produced in a reaction which also yields energy as a byproduct which may be harvested for use. The reaction imparted by the method herein, of deuterium ions to form helium-4, by the herein disclosed electromagnetic mechanism in operation, is also descriptively termed “electromagnetic element reactions.”

The conventional employment of extensive heat and compression techniques to form recoverable helium from hydrogen or deuterium ion precursors has a primary technical problem of extremely low yields. An example of this conversion problem is demonstrated by the known low conversion process of earth's sun. By operation, the sun employs extreme heat and pressure to helium precursors, yet this process on a stellar scale, only converts an estimated 10⁻¹³ percent of fuel each year into helium. This minimal yield occurs in spite of the large potential energy gain for such a hydrogen to helium conversion.

Based upon observation of this very slow helium formation process by the sun, it is evident that such a heat and pressure reaction process is not efficiently promoted by random heat and compression mechanisms. Thus, prior art attempts noted herein, to produce helium (and harvestable energy), through the employment of circular arrays of magnets such as cyclotrons applied to hydrogen and deuterium plasmas, have universally failed to produce useful quantities of helium or resulting energy from helium precursors. This can be surmised based upon the recognition that those prior art efforts, which have essentially employed random compression reaction mechanisms, much like the sun, can be readily understood to be inefficient.

It is then evident that improving the yield process of a deuterium to helium conversion, by a method of employing a non-random, lower energy barrier (catalytic) reaction process, may be a primary technical problem which if surmounted, will yield an effective helium production device and method.

As such, the present disclosed method and device employ a novel and heretofore unanticipated apparatus as a particularly preferred means to reduce the energy barrier to the reaction of gaseous deuterium ions, to form helium. This reaction is accomplished by a novel disclosed means of electromagnetic element reactions. For reference, a non-polarized deuterium ion in its preferred state is represented in FIG. 2.

In order to create an apparatus and method yielding effective conditions for electromagnetic element reactions of deuterium ions to form helium, it was recognized based on the lacking in prior art, that such deuterium ions should be polarized and spatially positioned. Further this spatial positioning should be accomplished in a manner which minimizes electromagnetic repulsive forces between the ions and simultaneously maximizes electromagnetic attractive forces between these ions, prior to and during to the resulting reaction process.

In the present disclosed device and method, one such favorable geometrical alignment of two polarized deuterium ions immediately prior to their electromagnetic element reaction to form the helium nucleus, can be constructed as shown schematically in FIG. 3. According to the diagram of FIG. 3, and the method herein, a preferred geometrical alignment of any two deuterium ions, which favors an electromagnetic element reaction to proceed, will employ two adjacent deuterium ions which are configured and exhibit directionally opposite polar orientations. Such polarized and configured ions are enabled to form by fusion the instantaneous assembly of FIG. 4.

A set of force versus distance calculations has been discerned for two polar-oriented deuterium ions as these approach one another in space, based upon the sum of four attractive electromagnetic forces and five repelling electromagnetic forces according to the formula

force=Q/r²

where “Q” is the electrostatic force constant

(8.99·10⁹ Nm²/C²) and

“r” is the separation distance between charges.

The four individual attractive forces between two dipole-aligned deuterium nuclei are constituted by the forces between neutron-electrons with the neutron-protons and protons of the separate deuterium nuclei, while the five repelling forces are constituted by the actions of protons and neutron protons of the separate deuterium atoms arranged each other and including the repulsive force of the two separate neutron-electrons between each other.

In such a set of calculations, the radius of the neutron-electrons is taken as 2.82·10^{-15m} while the radius of the protons and neutron-protons is taken as 12.2 times greater than the neutron-electron radius.

According to the calculations noted herein, involving two preferably-aligned dipole-oriented deuterium ions, as the ions approach one another prior to an electromagnetic element reaction, there is a relatively low repulsive force peak as shown in FIG. 5.

Employing the above calculations for this abstract case, then the electromotive voltage required to overcome the maximum repulsive force of two ideally dipole-oriented deuterium ions, is estimated by the present invention, to be a relatively low threshold voltage of substantially 1000 volts.

As a consequence of this unexpected discovery, it is indicated that employment of a catalytic pathway, as a method of formation of helium from deuterium ions, is attainable through a method of deuterium ion dipole orientation which is configured to achieve the noted low repulsive force. With this technical solution identified, the present invention comprises a previously-unanticipated method for the formation of helium and resulting energy harvesting during the reaction, employing an equipment design and method of operation which forms helium-4 by first forcing proximate deuterium ions into electromagnetically-favorable induced dipole alignments, and subsequently impelling these so-oriented ions into electromagnetic element reactions, through the application of a directed electromotive force provided from same equipment employed for the first step of forcing proximate deuterium ions into electromagnetically-favorable induced dipole alignments.

Employing this method using the disclosed equipment or other equipment as would occur to those skilled in the art for inducing such dipole alignments, a catalytic pathway is provided for the formation of helium, from deuterium ions, which also yields harvestable energy during the operation.

Employing the herein disclosed method, two populations of deuterium ions are configured to become significantly more reactive to each other by creating a lower energy barrier (catalytic) orientation of these ions. Prior to the resulting reaction, the method herein first employs a novel means of mechanical movement and/or gas pressure, to rapidly transport the two formed populations of ions, in opposing directions to one another within a strong single vector magnetic field.

Through this rapid transporting of the two different populations of deuterium ions, in opposite directions, within a powerful single vector magnetic field the method herein, the system herein induces the two sets of deuterium ions, to adopt oppositely-facing polarity alignments. As noted above, this is calculated to be the preferred configurations of the two ion species, which is most conducive to their potential electromagnetic element reactivity.

This polarity-inducing step of the method and the resulting effect is due to the fact that negative charges such as those of neutron-electrons, moving rapidly within a single vector magnetic field, are forced to move one direction in space. Concurrently, positive charges moving similarly through the same magnetic field are impelled to move the opposite direction in space, compared to the movement in direction of negatively charged electrons. Thus, in an ion, where a negative charge is closely associated with two positive charges, as in the case of a deuterium ion, by movement of this ion species rapidly within a magnetic field, the deuterium ion must develop a charge polarity orientation in space.

Consequently, as disclosed herein, where two species or populations of deuterium ions, are caused to move in opposite directions within a magnetic field, these two populations will concurrently assume respective opposite charge polarity orientations, and opposite direction polarity alignments, with respect to each other. These so-formed respective two deuterium ion populations, which express opposite direction polarity alignments, are in a subsequent step in the method herein, communicated to a convergence point of a physical intersection with one another.

During positioning at this convergence point, the proximate members of the two ion populations, are subjected a directional electromagnetic force, proximate to the convergence point. This directional electromagnetic force, is substantially or exceeds 1000 volts in the present mode of the method herein, although those skilled in the art will discern that other voltages may be employed. The ions proximate to this convergence point in the directional electromotive force projected thereto, result in a high percentage of electromagnetic element reactions. These reactions form helium and waste energy.

As can be discerned from the above description of the method and apparatus employed therefor, the present method and device therefor differs significantly with respect to theory of operation, the nature of equipment employed and operating processes from all prior art. As such, the disclosed device provided a novel means for creation of helium and resulting waste or reaction energy both of which may be harvested, from gaseous deuterium ions.

With respect to the above description of the method and device therefor, before explaining at least one preferred embodiment of the herein disclosed invention in detail, it is to be understood that the invention is not limited in its application, to the details of construction and to the arrangement of the components of the device, nor the steps in the method, in the following description or illustrated in the drawings. The invention herein described is capable of other embodiments and of being practiced and carried out in various ways which will be obvious to those skilled in the art upon reading this disclosure. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the formation of helium and the several purposes of the present disclosed device and method herein. It is important, therefore, that the claims be regarded as including such equivalent construction and methodology insofar as they do not depart from the spirit and scope of the present invention.

### BRIEF DESCRIPTION OF DRAWING FIGURES

FIG. 1 depicts the system herein and the electromagnetic stabilization of helium-4 and is representative of the attractive and repulsive forces operating within that atom.

FIG. 2 shows a schematic view of Deuterium ion showing a natural state thereof with non-polar spatial distribution of charges.

FIG. 3 shows two deuterium ions and illustrates the opposite orientation dipoles taught herein as well as the attractive forces acting between the two separated ions.

FIG. 4 provides a schematic view of a helium nucleus showing the dual-charge neutrons.

FIG. 5 depicts a schematic showing force versus distance “profile for two dipole-oriented polarized deuterium ions as these approach one another in space.

FIG. 6 is an abstract schematic view of four proposed attractive forces and five repulsive forces acting between two deuterium nucleon sets within a helium nucleus.

FIG. 7 shows a schematic view of an electromagnetic element reactor, and components including a mechanical rotating wheel as a means for developing the emf for the disclosed method.

FIG. 8 depicts a side view of FIG. 7.

FIG. 9 depicts another mode of the device replacing the mechanical moving wheel of FIGS. 7-8 with a non moving solid surface 40.

FIG. 10 shows FIG. 9 from a side view.

### DETAILED DESCRIPTION OF THE PREFERRED

### Embodiments of the Invention

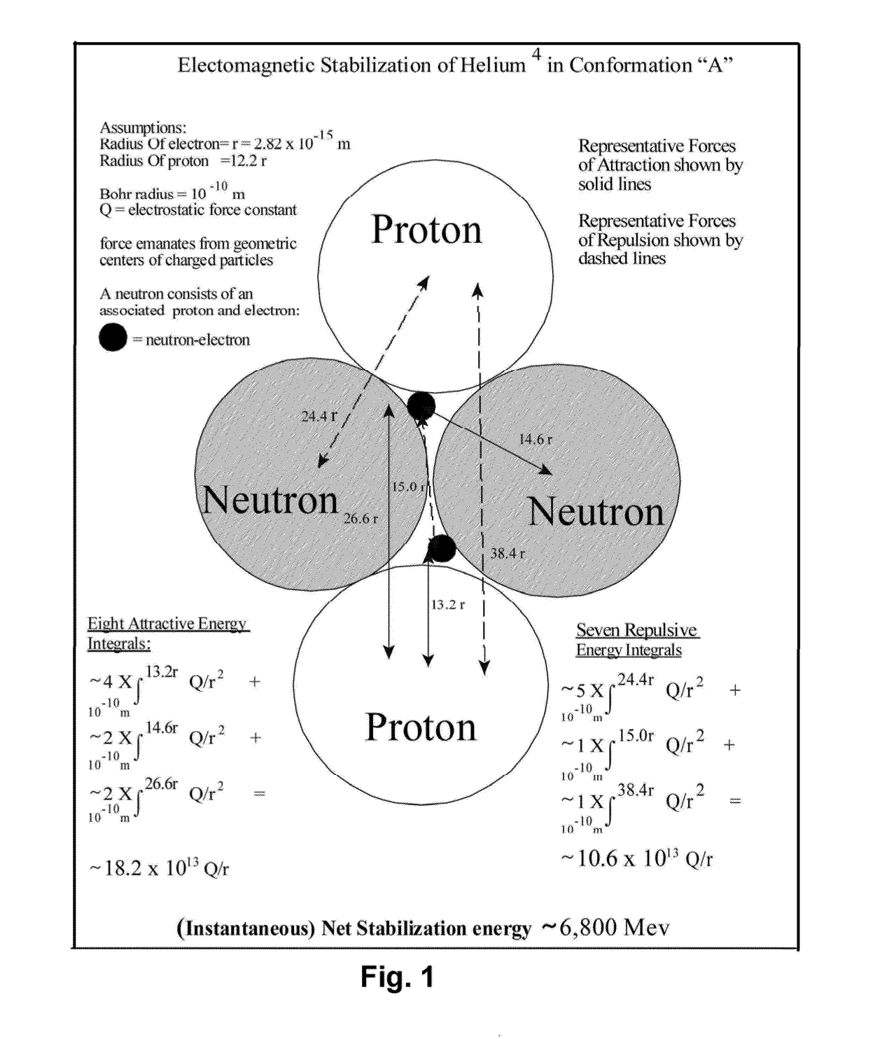

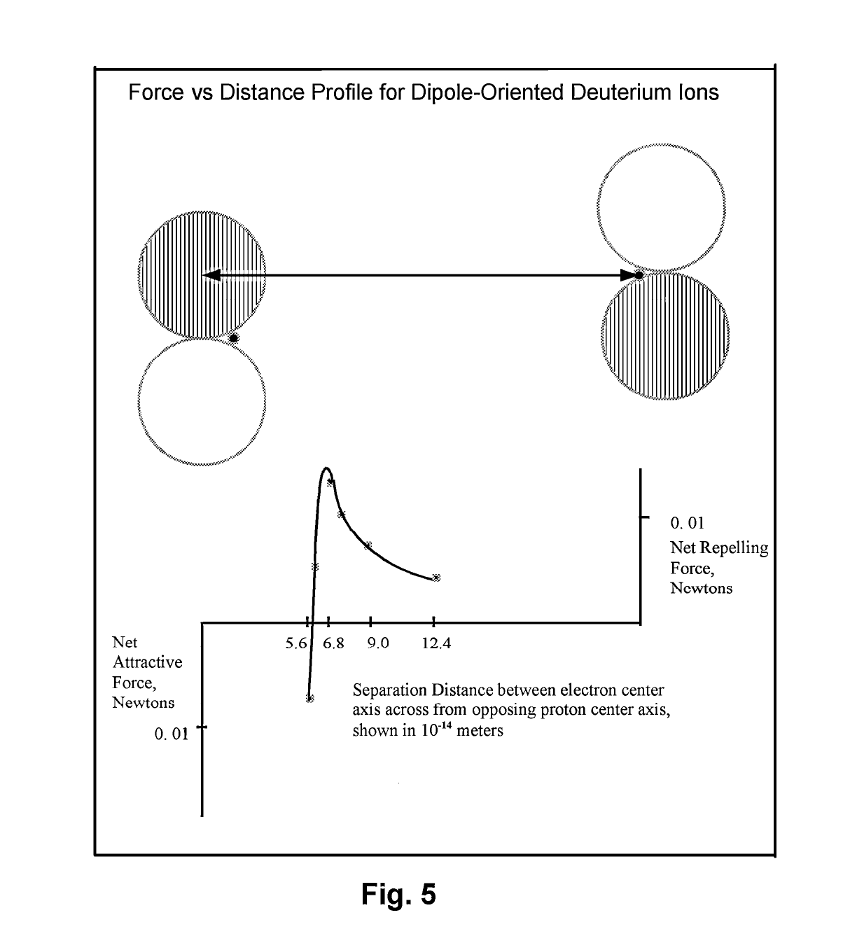

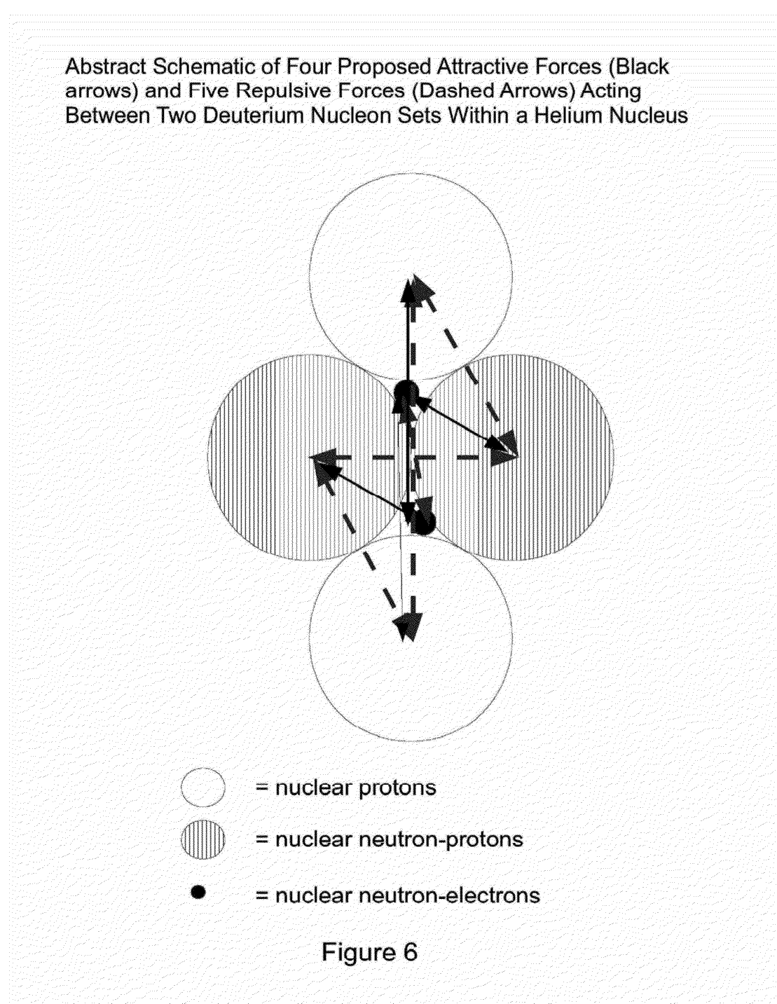

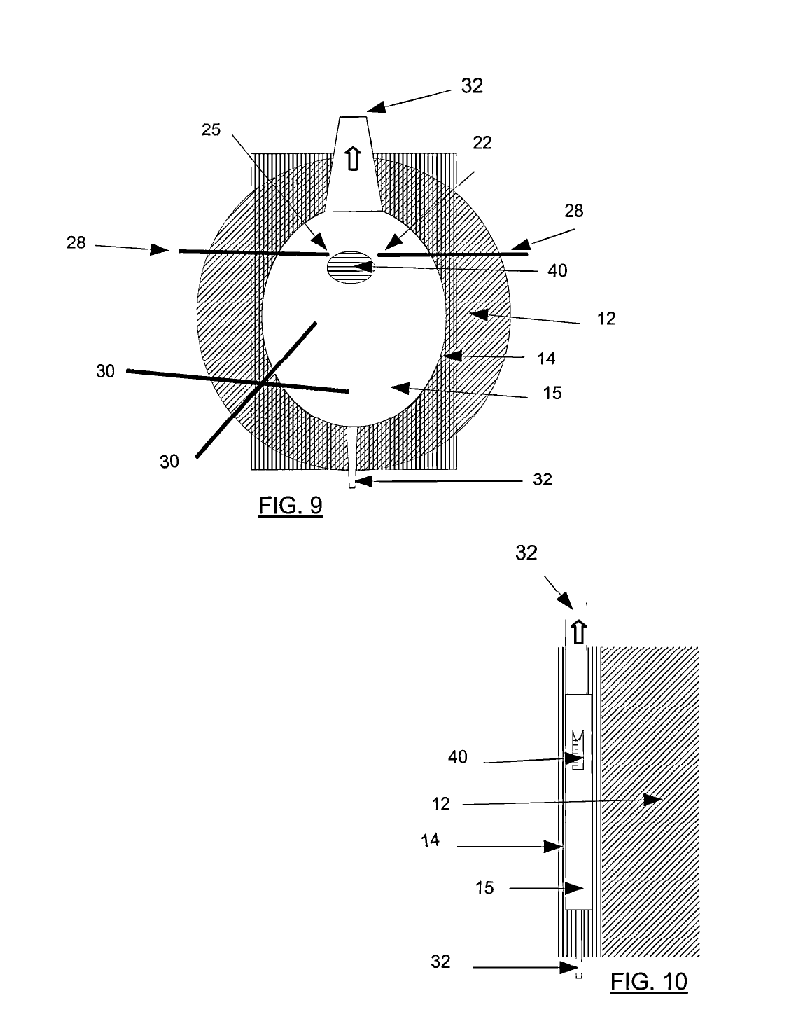

Referring now to the drawings of FIGS. 1-10 which depict modes of the device 10 and method herein. The disclosed method and device 10, provides a system for impelling lower energy barrier (catalytic) electromagnetic element reactions between deuterium ions, thereby producing useful helium-4. The method herein, using a combination of coordinated forces including surface force (optionally), a single vector magnetic force, motion-related mechanical force, gas pressure flow force (or other directional physical flow) and electromotive force to achieve the reactions between deuterium ions. A representative depiction of the forces and the calculations thereof can be viewed in FIG. 1 herein which provides such calculations validating this method and apparatus along with a simple schematic allowing an easy understanding of the noted forces.

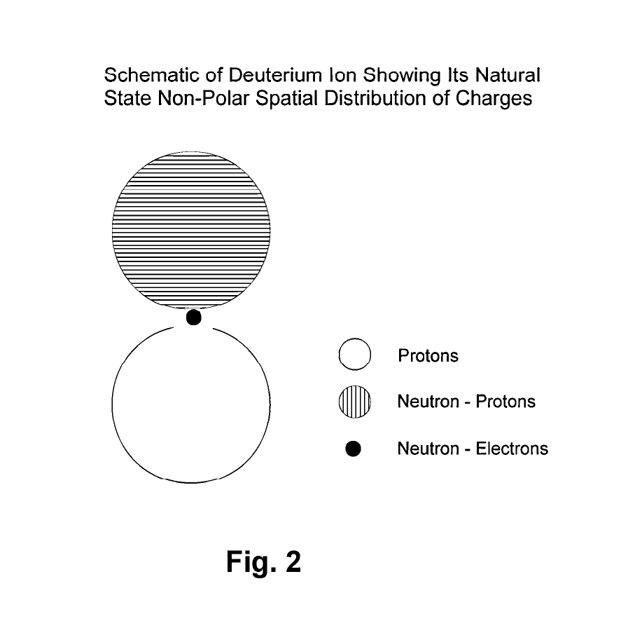

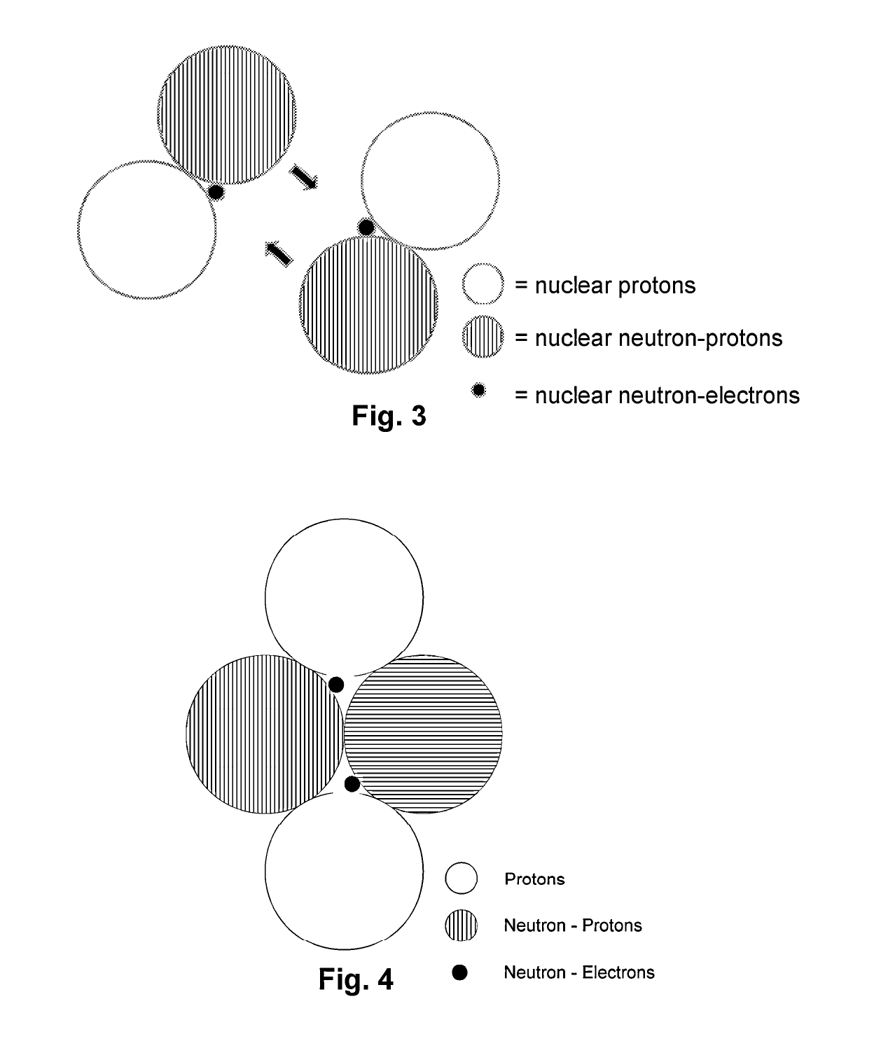

In all modes of the device 10 to enable and coordinate the method herein, two populations of deuterium are employed, which express opposite direction polarity alignments such as in FIG. 3, which are urged to this disposition from their natural non-polar state of FIG. 2. These populations are moved from the configuration of FIG. 2, to these opposing directions of FIG. 3, by physically transporting these ion populations in opposite directions within a strong single vector magnetic field. (A“single vector” magnetic field is one with a predominant force direction completely unlike a cyclotron magnetic field that is multi-directional).

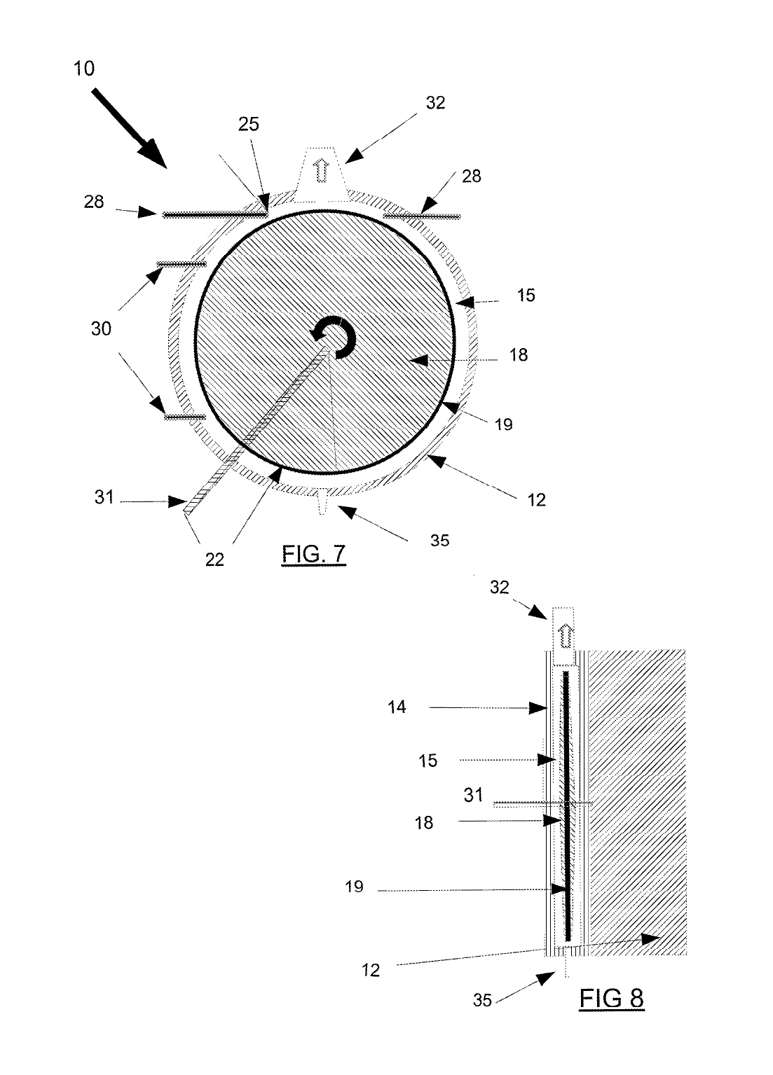

Moving in this magnetic field, the two populations which as noted, express opposite direction polarity alignments as depicted simply in FIG. 3, simply in FIG. 3, are physically directed to convergence at an intersection point as is explained below with regard to FIGS. 7-10.

Concurrently, a strong directional electromotive force is communicated to and around this intersection point, to drive electromagnetic element reactions between members of the two deuterium ion populations, thereby forming helium. Concurrent with helium formation, energy is released which may be harvested.

In a preferred mode of the method herein, to yield the disclosed deuterium chloride gas reaction, a first population of deuterium ions are adsorbed upon or associated in movement with a physically-moving surface, within a single-vector magnetic field. A second population of deuterium ions is simultaneously directed in movement to an intersecting but counter-directional flow of a first population of ions (that is associated with the moving surface), by deuterium gas pressure flow and voltage driven current flow of this second population deuterium ions.

Another preferred mode of the disclosed method of helium formation herein, employs two high-pressure gas streams of deuterium ions. The two streams with each having respective populations of deuterium are employed, which express opposite direction polarity alignments, are communicated in opposing directions, within a strong single-vector magnetic field, to a point of intersection of the ions at a negatively charged surface. At this point of intersection, a strong directional electromotive force is communicated to the intersecting ion streams, to drive electromagnetic element reactions of the two deuterium ion populations thereby forming helium.

While the apparatus herein disclosed in general in FIGS. 7-8, provides current means for imparting a directionalized flow of ion streams of respective populations of deuterium which express opposite direction polarity alignments, which is the basis of this method for forming helium, any device as those skilled in the art would employ to accomplish this intersecting flow using streams of directional ion configuration herein disclosed is considered within the scope of this application.

The method of communicating the coordinated forces of the present invention which as noted may be handled in other fashions, includes at least one means of surface force, one means of mechanical force, one or a plurality of means for directing gas pressure forces, one means for projecting magnetic force and one means for imparting electromotive force to deuterium ions to yield the electromagnetic element reactor device 10 herein.

In FIG. 7 a mode of the device 10 is shown enabling the method and object of this invention in the formation of helium and harvestable energy is depicted with components thereof. A magnet 12, which may be an electromagnet or strong fixed magnet is provided. Also provided is a reaction chamber housing 14 preferably composed of magnetic susceptible material. The housing 14 is preferably coated on its interior wall 15, which defines an interior cavity, 16, with acid resistant material.

A means for rotational movement, such as a wheel 18 which is rotationally engaged to a source of power such as an electric motor, within the reaction chamber 16, is configured on an outer perimeter surface 19 area to attract deuterium ions both through adsorption and by means of the application of a negative electromotive charge to this surface through application of an external emf connection 22 in FIG. 7.

A gas injection port 28 is provided for communicating deuterium gas into the reaction chamber 15. An electromotive circuit has a negatively charged pole 22 the mechanically movable surface, which has the positively charged pole 25 located as part of, or proximate to the deuterium gas injection port 28. Also shown are spray inlets 30 for communication of water or deuterium oxide to the reaction chamber 15 as a means for cooling. A takeoff port 32 for communication of steam and recoverable helium from the reaction chamber 15 is provided and in an operative communication therewith.

A large diameter circularly wound magnet 12 such as an electromagnet is preferably capable of generating a magnetic field in excess of 10,000 gauss in the current mode. One especially preferred feature of the magnet 12 is that it communicates the magnetic field force within the reaction chamber 15, in which two deuterium ion populations which express receptive opposite direction polarity alignments, are moving in opposing directions, and proximate thereto, at an intersection point of a deuterium chloride gas spray, which is injected into the reaction chamber 15, and the mechanically moving surface, within the reaction chamber 15.

The direction of the wiring of the magnet 12, such as the electromagnet, or fixed magnet 12 analogue must be coordinated with the other operational components of the present invention. More particularly it must be coordinated with the direction of emf current flow 22, and the direction of movement of the mechanically moving surface 19 on the perimeter of the moving wheel 18, as are described further below. The reaction chamber housing 14 is preferably constructed of magnetic material which is positioned adjacent to the magnet 12 such as the electromagnet in a manner that magnetic force is exerted into the reaction chamber 15 defined by the wall of the housing 14. The housing 14 is coated on an interior surface defining the reaction chamber 15, preferably with acid resistant, electrically insulating material, such as a high temperature glass. This may be affixed for instance using acid resistant high temperature-tolerant resin. The interior of the housing 14 is adapted to conform spatially with and enclose the movable wheel 18 or other movable component as described below, with as close spatial tolerance as practical. Gaskets and seals where employed must be of high temperature acid resistant and electrically insulating.

The movable component within the reaction chamber 15 which, as noted, may be a wheel 18 or other movable component, such as a rod or band, may have a surface of acid resistant or coated material which is enclosed within the reaction chamber 15 of the housing 14. Motion or rapid rotation of the moving component such as the wheel 18 within the interior of the housing 14 is provided by means of a mechanical drive shaft 35 communicating in a sealed engagement with the exterior of the housing 14, with means for powered rotation such as an electric motor.

As shown, for instance using a wheel 18 having the movable surface, a central drive shaft 31 communicating through the wheel 18 center, is operatively engaged with sealed acid resistant bearings on both sides, and the proximal end of the drive shaft 31, providing means to rotate the wheel 18 so that this wheel 18 and its surface, can be rotated at high speed within the housing 14 with the outer surface 19 of the wheel 18 intended as the general location of deuterium ion reactions.

The operational relationship between the mechanical moving surface 17 direction, such as that on the wheel 18, and the applied magnetic field, is such that positive charges moving in the same direction as direction of the rotation of the wheel 18 are impelled by the magnetic field to move towards the moving wheel surface 19.

The moveable component has a surface 19 associated with it that has an affinity for deuterium ions. This surface 19 may consist of a band or layer of an electrically conducting acid resistant material, such as gold or other analogues that is affixed to the outer perimeter of the movable wheel 18. Or, this surface may consist of graphite.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A method for production of helium and recoverable energy comprising:
imparting a first directionalized flow of a of a first streaming population of deuterium ions;
imparting a second directionalized flow of a second streaming population of deuterium ions, where each of said second streaming population of deuterium ions has a respective opposite direction polarity alignment to that of each of said first streaming population of deuterium ions;
directing said first streaming population of deuterium ions having said first directionalized flow to an intersection position with second streaming population of deuterium ions having said second directionalized flow, within a reaction chamber being subjected to magnetic flux;
communicating a high voltage electrical charge between two electrodes located at separate points in electrical communication with said intersection position, thereby generating controllable rates of electromagnetic element reactions between colliding said deuterium ions from respective said first streaming population and said second streaming population, to form helium, and;
capturing said helium.

2. An electromagnetic reactor apparatus for production of helium through the method of claim 1, comprising:
a housing, said housing having a wall having a first surface defining an interior cavity;
said wall having an interior surface said first surface, said interior surface being electrically insulated;
at least one entrance port communicating with said interior chamber;
means for communicating first and second gas streams into said reaction chamber through said entrance port, said gas streams formed of deuterium chloride gas streams or deuterium ion plasma streams;
means for imparting a first directionalized flow to said first gas stream containing deuterium ions;
means for imparting a second directionalized flow to said second gas stream containing deuterium ions, said second directionalized flow being in an opposite direction polarity alignment to that of said first directionalized flow of said gas stream containing deuterium ions;
means to direct said first directionalized flow and said second directionalized flow to an intersecting position therebetween, within an inner volume of said interior chamber, whereby deuterium reactions are enacted between respective ions from each of said first directionalized flow and said second directionalized flow, at said intersecting position;
a takeoff port in communication with said interior chamber, said takeoff port vented to an exterior cooling component for communicating heat generated by said deuterium reactions within said interior cavity, with a coolant;
means to capture helium gas generated by said deuterium reactions and communicated to said takeoff port; and
means to capture steam generated by said coolant communicating with said heat, and communicated from said takeoff port, whereby said steam may be communicated to a heat exchanger for communication to a component requiring heat.

3. The electromagnetic reactor of claim 2, additionally comprising:
an electromotive system located within the reaction chamber having at least two separate electrode locations positioned within said first and second directionalized flows of deuterium ions; and
high voltage in excess of 1000 volts between said two electrodes thereby generating controllable rates of electromagnetic element reactions between colliding said deuterium ions from respective said first streaming population and said second streaming population, to form helium.

4. The electromagnetic reactor of claim 3, additionally comprising:
said high voltage being in excess of 10,000 volts applied between said two electrodes.
